(19) United States
(12) Patent Application Publication
(10) Pub. No.: US 2006/0066204 A1
(43) Pub. Date: Mar. 30, 2006

(54) Triode structure for cathode ray tube electron gun

(75) Inventors: Jean-Luc Ricaud, Dijon (FR); Nicolas Richard, Dijon (FR)

Correspondence Address: THOMSON LICENSING INC., PATENT OPERATIONS, PO BOX 5312, PRINCETON, NJ, 08543-5312, US

(73) Assignee: THOMSON LICENSING

(21) Appl. No.: 11/240,985

(22) Filed: Sep. 30, 2005

(30) Foreign Application Priority Data
Sep. 30, 2004 (FR) 0452204

(51) Int. Cl. H01J 29/50

(52) U.S. Cl. 313/412; 313/414

(57) ABSTRACT

The invention relates to an electron gun triode for a cathode ray tube in which the cathode has a projecting emissive zone, centred on the Z-axis of the gun and which advances toward the first electrode. The projecting emissive zone does not have any rotational symmetry around the said first axis.

### BACKGROUND OF THE INVENTION

The invention relates to an electron gun triode for a cathode ray tube.

An electron gun of a cathode ray tube comprises a cathode emitting electrons by thermoemission and two electrodes that initialise the formation of an electron beam from the electrons emitted by the cathode. A point of focus is thus formed. The size of this point of focus is as specific as possible. This point of focus will be called “crossover” in the rest of the description.

FIG. 1 schematically shows such a triode applied to an electron gun for a color cathode ray tube. The cathode and both electrodes are aligned according to the Z-axis.

The Z-axis is the main longitudinal axis of the electron gun, the 3 electron beams red green and blue travelling essentially parallel to the Z-axis.

The horizontal X-axis is perpendicular to the Z-axis and passes through the 3 centres of the red, green and blue apertures of the electrode G1.

The vertical Y-axis is perpendicular to the axes X and Z and passes through the centre of the green aperture of the electrode G1.

The form, position and extent of the crossover of an electron gun are caused by the fact that as soon as they have been emitted by the emissive zone of the cathode K, they undergo, between the cathode and the electrode G1, the action of a highly convergent electronic lens. In other words, the electrons emitted further than the emissive zone have trajectories whose angles with respect to the longitudinal Z-axis axis of the gun are much greater. Consequently, the trajectories of the beam cross the Z-axis at different Z positions and with different angles: hence the extent of the crossover in Z and in the transversal (in the plane (X Y).

Moreover, the moving of the crossover, when the beam current varies, is caused by two effects:
(1) The greater the beam current, the further the electrons are emitted from the centre of the emissive zone, thus producing the effects described in the paragraph above.
(2) The greater the beam current, the less convergent is the cathode/electrode G1 lens, so the more the trajectories cross further from the cathode. As effect (2) is more dominant than effect (1), the position of the crossover moves away from the cathode when the beam current increases. The result is that the optimum focalisation by the main lens of the gun varies according to the beam current. This is called “focus tracking” and the electron gun designer seeks to reduce it.

Hereafter, the surface capable of emitting electrons is called the emissive surface. According to the triode chosen and the electrical parameters selected for its operation, a more or less extended portion of the emissive surface effectively emits the electron beam.

In a standard electron gun, such as the one described in the patent U.S. Pat. No. 5,760,550 equipped with an astigmatic beam forming region (BFR), a dissymmetric aperture is designed in the part of the first electrode G1 that is opposite the cathode, namely an aperture that has no rotational symmetry around the Z-axis, and that is axisymmetric. This aperture is, for example, rectangular or elliptical or diamond-shaped. In such an electron gun, the ovalisation of the beam and the astigmatism are not independent as they are both related to the shape of the emissive zone, the astigmatism being moreover related to the forces of the convergent lens cathode/G1 in the horizontal plane and the vertical plane. The ovalisation and astigmatism vary when the beam current varies (because the emissive zone varies). The fact that the ovalisation and the astigmatism are not independent is illustrated by the FIGS. 2a to 2d. These figures represent an electron gun triode in which the apertures of the electrode G1 take the shape of a rectangle whose largest dimension is according to the vertical axis Y. FIGS. 2a and 2b show the triode operating at a low electron beam current, FIG. 2a being according to the plane XZ and FIG. 2b, according to the plane YZ. FIGS. 2c and 2d show the same triode operating at a high electron beam current.

These figures show that, owing to the dissymmetry between the horizontal plane and the vertical plane, the force of the cathode/electrode G1 lens has a dissymmetry between the horizontal plane and the vertical plane such that the horizontal crossover is separate from the vertical crossover.

Moreover, the U.S. Pat. No. 4,091,311 describes a flat annular cathode capable of creating a tubular electron beam “hollow beam” in the electron gun. This annular cathode is set in an assembly formed by the cathode and an electrode G1 and an electrode G2. FIGS. 3a to 3c show the case of a triode fitted with a flat annular cathode for two electron beam current values. It is noted that when the beam current is greatest, the crossover changes location, but the emissive zone retains approximately the same extent. The annular shape has the following advantages over a standard flat cathode whose emissive zone is in the form of a disk:
a smaller movement of the crossover when the beam current varies, as the zone emitting the beam enlarges (when the beam current increases) on either side of the median ring of the annular zone, such that the crossover enlarges according to the Z-axis but its barycentre hardly moves.
a smaller modulation in the video control voltage (lower “drive amplitude”), which enables the drive circuit to be simplified and reduce the electrical power used.
a reduction of the television picture artefact known as “moire” owing to a lesser finesse of the electronic spot at low beam current values, thanks to the fact the crossover hardly changes its Z location when the beam passes from a high to a low current.

The patent application Ser. No. WO02052599 describes variants of annular cathodes that have one or more annular protuberances rising above the main surface of the cathode. The protuberances have a rotational symmetry and have a semi-toroidal or similar shape.

FIGS. 4a to 4c show a triode equipped with such a cathode. The emissive surface is projecting with rotational symmetry, and the entire triode has rotational symmetry. FIGS. 4b and 4c show the operation of this triode for two beam current values. It is noted that when the beam current is greatest, the crossover changes location, but the emissive zone retains approximately the same extent. The emissive zone is slightly more extended as it occupies a slightly more extended region on either side of the summit zone of the projection,

Whereas a cathode having a flat crown emissive zone has the property of restricting the evolutions of the crossover by limiting the emissive zone at the crown, this property is obtained in the case of a protuberant emissive zone because this protuberance experiences a stronger electrical extraction field and therefore the emission is restricted in this zone.

These protuberant ring emissive cathodes have the same advantages as the flat ring emissive zone cathodes, listed above. But they also have the advantage of more restricted emissive zones for a given beam current, therefore a reduced spot size on the screen and therefore a better image resolution.

The disadvantage is that the emissive zone remains rotationally symmetric, so the ovalisation and astigmatism are not independent, and in particular they cannot be adjusted independently during the design.

### SUMMARY OF THE INVENTION

One object of the invention is to obtain at the output of the electron beam forming region, an electron beam whose ovalisation (degree of dissymmetry of the current density profile between the horizontal plane XZ and the vertical plane YZ) and the astigmatism (spacing along the Z-axis between the horizontal crossover and the vertical crossover) can be adjusted independently when designing the electron gun and vary little when the electronic beam current varies.

The invention therefore relates to an electron gun triode for cathode ray tube comprising, arranged according to a first axis, a cathode as well as a first electrode whose potential is smaller on the scale of algebraic numbers, that is taking into account the sign, than that of the cathode and a second electrode whose potential is greater than that of the cathode. The cathode has at least one projecting emissive zone, centred on the said first axis and advancing toward the first electrode. The electrodes each have an aperture centred on the first axis. According to the invention, the projecting emissive zone does not present a rotational symmetry around the said first axis.

According to one form of embodiment, the aperture of the first electrode does not have any rotational symmetry with respect to the first axis.

In general, the spacings measured in projection on a plane, defined by a second and third axis perpendicular to the said first axis between the summit line and the edge of the electrode aperture edge are different according to the second and third axes.

Advantageously, the projecting emissive zone has two symmetry planes containing the first axis.

The aperture of the first grid can also have two symmetry planes containing the first axis.

The largest dimension of the projecting emissive zone measured on the summit line is less at the diameter of the aperture of the first electrode.

According to one form of embodiment, the orthogonal projection of the summit line of the protuberance projecting from the plane of the first electrode is within the aperture of this first electrode.

The summit line of the projection preferably has the shape of first rectangle whose ratio of dimensions determines the current density profile emitted and thus determines the beam ovalisation.

Also, the part of the aperture of the first electrode that is opposite the cathode has the shape of a second rectangle whose sides are parallel to those of the first rectangle, the ratio of the spacing between the sides of both rectangles measured in parallel to the second axis at the spacing between the sides measured in parallel to the third axis determines the distance between the horizontal crossover and the vertical crossover, thus determining the astigmatism of the electron beam.

It is also possible to ensure that the cathode has several projecting emissive zones, these zones not having rotational symmetry around the said first axis.

The invention is applicable to an electron gun for a color cathode ray tube comprising three triodes thus described and arranged in parallel to the said first axis.

### BRIEF DESCRIPTION OF THE DRAWINGS

The different objects and characteristics of the invention will appear more clearly in the description that follows as well as in the annexed figures, wherein:

FIGS. 1 to 4c, different states of the technique already described above,

FIG. 5, an embodiment of an electron gun triode according to the invention,

FIGS. 6a to 6d, of the operating modes of the triode of FIG. 5, with a low electron beam current and high electron current,

FIG. 7, a variant embodiment of the triode according to the invention,

FIGS. 8a to 8d, of the operating modes of the triode of FIG. 7, with a low electron beam current and high electron current,

FIGS. 9a and 9b, a triode according to the invention in which the cathode comprises several projecting emissive zones.

### DETAILED DESCRIPTION OF THE PREFERRED EMBODIMENTS

The basic arrangement of the invention is as follows:

A) give the protuberant projecting emissive zone a non-rotational symmetric form in the plane XY, for example by giving it a rectangular form at the summit line of the projection. One thus creates a geometric dissymmetry effect of the emitted current density profile, so to speak an ovalisation of the beam.

B) Provide an electrode G1 aperture with a non-rotational symmetric form in the plane (X, Y), by choosing the spacings, measured in projection in the plane (X, Y), between the projection of the cathode and the edge of the aperture so that they are different according to X and according to Y. The locations on the Z-axis of the horizontal crossover and the “vertical crossover” are determined in this manner, in other words, the astigmatism of the beam is controlled. Indeed, the emissive zone remains restricted and fixed spatially on the projection whereas the dimensions of the aperture according to X and according to Y control the curves of the equipotential lines on the projection and thus control the angular directions of the trajectories, and finally control the locations on the Z-axis of the “horizontal crossover” and the “vertical crossover”.

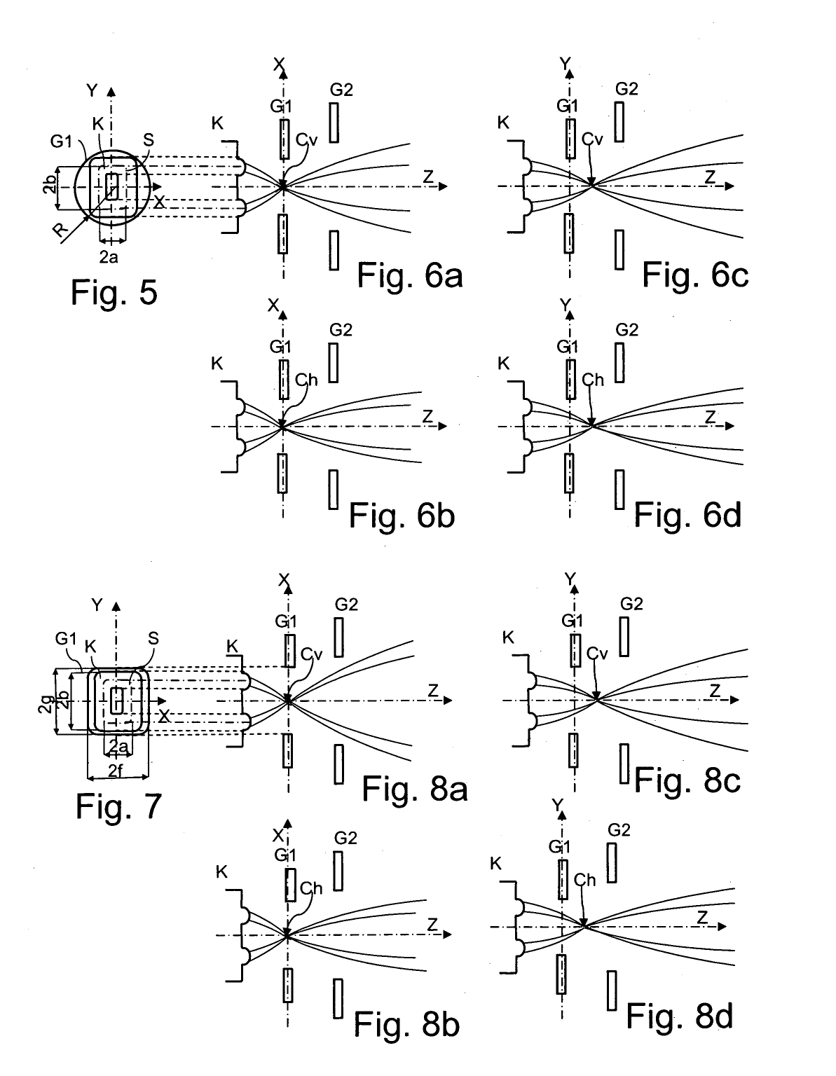

FIG. 5 shows a first embodiment of the invention, in which the projection is not rotationally symmetric but is rectangular. For example, the summit line S of the projection is a rectangle whose width parallel to the plane XZ is 2a and whose length parallel to the plane YZ is 2b.

The aperture of the electrode G1 is rotationally symmetric around the Z-axis. This aperture has a radius R.

According to the embodiment of FIG. 5, the diameter of the aperture of the electrode G1 is greater than the diagonal of the rectangle of the projection. This diameter will be preferably designed to be at least greater than the diagonal of the rectangle formed by the summit line of the projection S. The orthogonal projection of the summit line on the plane of the electrode G1 thus falls within the circumference of the aperture of this electrode.

FIGS. 6a and 6d show the operation of this triode for two values of the electron beam current. FIGS. 6a and 6b show an operation at low beam current and FIGS. 6c and 6d, an operation at a higher beam current.

It is noted that when the beam current is higher, the crossover changes location but the emissive zone is slightly more extended as it occupies a more extended region on either side of the summit zone of the projection. It is also noted that because the equipotential lines located between the cathode and the aperture of the electrode G1 are all the more curved and less parallel to the plane XY that they are far from the Z-axis. The beam is emitted by the sides of length 2a of the projecting rectangle by forming with the Z-axis an angle that is all the greater as the ratio a/R becomes greater. Hence, this ratio a/R determines the location, on the Z-axis, of the “horizontal crossover” Ch. In the same manner, the ratio b/R determines the location, on the Z-axis, of the “horizontal crossover” Cv. (FIGS. 6b and 6d).

In these conditions, the distance between the horizontal crossover Ch and the vertical crossover Cv is determined by the ratios a/R and b/R of the dimensions of the rectangle of the projection at the radius R of the aperture of the first electrode. These ratios thus enable the astigmatism of the system to be determined.

Moreover, by acting on the dimensions of the projection and selecting a ratio of the dimensions a/b, the ovalisation of the beam emitted is determined.

FIG. 7 shows another embodiment of the invention, in which the projection is rectangular, the summit line being a rectangle whose width in the plane XZ is 2a and whose length in the plane YZ is 2b.

The aperture of the electrode G1 is also rectangular. The aperture of the electrode G1 is rectangular in shape whose width in the plane XZ is 2f and whose length in the plane YZ is 2g.

FIGS. 8a to 8d show, for two values of the beam current, the operation of the system of FIG. 7.

It is noted that the ratio a/f governs the location, on the Z-axis, of the “horizontal crossover” Ch (FIGS. 8b and 8d) and that the ratio b/g determines the location of the “vertical crossover” Cv (FIGS. 8a to 8c).

One can therefore consider that the ratio of the spacing (f-a) between the sides of the two rectangles measured parallel to the second axis (X) at the spacing (g-b) between the sides measured parallel to the third axis (Y) determines the distance between the horizontal crossover and the vertical crossover thus determining the astigmatism of the electron beam.

It is also noted that the ratio a/b controls the geometric dissymmetry of the emitted current profile and therefore the ovalisation of the beam and that this ovalisation is independent from the locations of the crossovers.

In the previous examples, the projecting emissive zone of the cathode was considered to have a rectangular shape in the plane XY. Without falling outside the scope of the invention, it could have another shape such as an elliptical shape such that two different dimensions can be obtained according to the axes X and Y.

With regard to the part of the aperture of the electrode G1 that is opposite the cathode, it can have a square shape instead of a shape with rotational symmetry (as in FIG. 5). Or else, it can have an oval shape instead of the rectangular shape of FIG. 7.

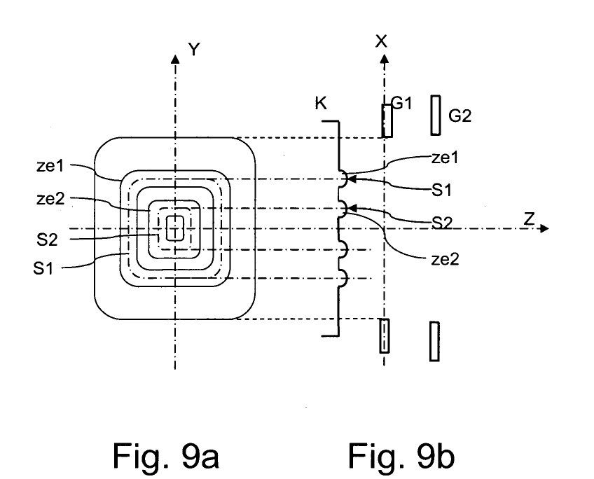

In the preceding description, a cathode with a projecting emissive zone was provided for. However, the invention is also applicable to a triode in which the cathode has several projecting emissive zones. For example, the FIGS. 9a and 9b show a triode in which the cathode comprises projecting zones ze1 and ze2. These zones are generally rectangular shapes and their summit lines S1 and S2 are equidistant.

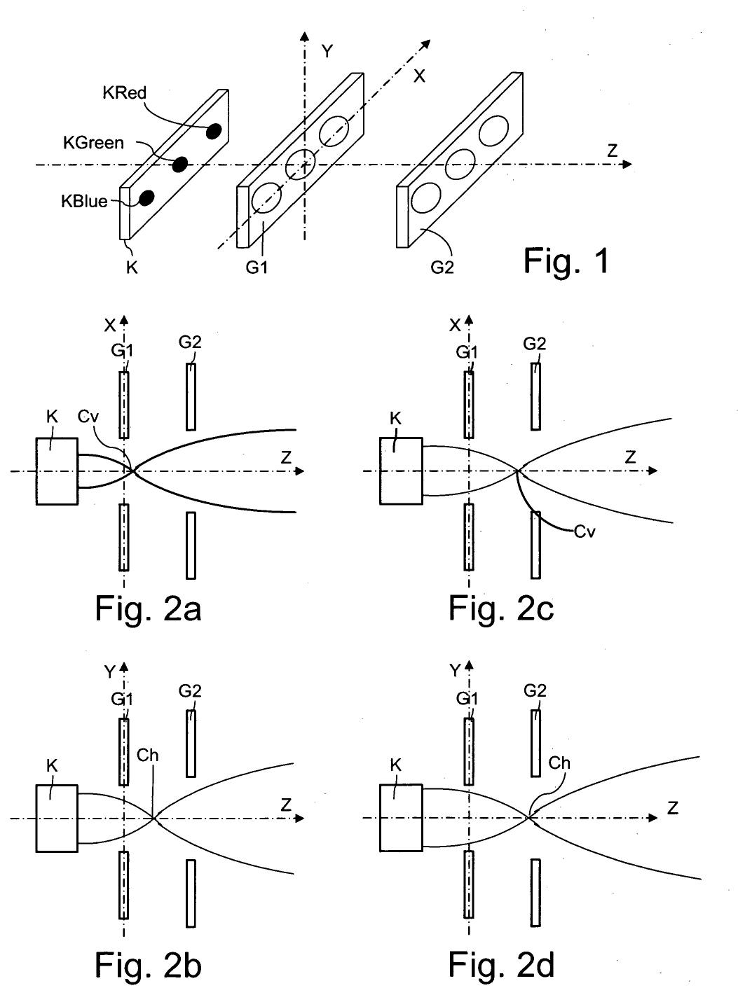

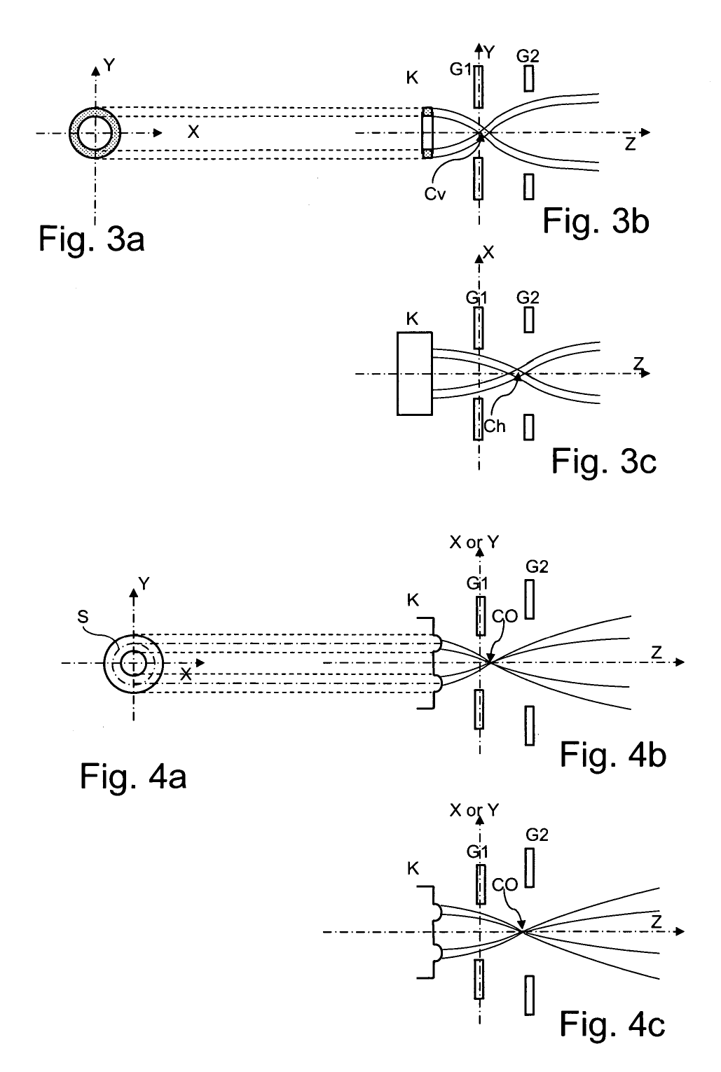

In the above description, a description was given of the shape of the central cathode and the aperture of the electrode located according to the Z-axis, which corresponds to the part of the gun emitting an electron beam designed to excite the green pixels of the screen of a colour cathode ray tube. The cathodes and the apertures of the electrode G1 located on either side of the Z-axis (FIG. 1) and which excite the red and blue pixels will be constituted in a similar or even identical manner.

The invention is applicable advantageously to an impregnated cathode, for which the form of the emissive surface can be chosen accurately.

What is claimed is:

1. Electron gun triode for cathode ray tube comprising, arranged according to a first Z-axis, a cathode (K) as well as a first electrode (G1) whose potential is algebraically lower than that of the cathode and a second electrode (G2) whose potential is more positive than that of the cathode, the said electrodes each possessing an aperture centred on the said first axis (Z), the cathode possessing at least one projecting emissive zone, centred on the said first axis (Z) and advancing toward the first electrode, the said projecting emissive zone not having a rotational symmetry around the said axis (Z), wherein the aperture of the first electrode does not have any rotational symmetry with respect to the said first axis (Z).

2. Electron gun triode according to claim 1, wherein the spacings measured in projection on a plane (XY), defined by a second and third axis (X, Y) perpendicular to the said first axis (Z) between the summit line of the projecting emissive zone and the edge of the electrode (G1) aperture edge are different according to the second and third axes (X, Y).

3. Electron gun triode according to claim 2, wherein the projecting emissive zone has two planes of symmetry (XZ and YZ) containing the first axis (Z).

4. Electron gun triode according to claim 3, wherein the aperture of the first grid has two planes of symmetry (XZ and YZ) containing the first axis (Z).

5. Electron gun triode according to claim 1, wherein the largest dimension (b) of the projecting emissive zone measured on the summit line is less than the diameter of the aperture of the first electrode (D1).

6. Electron gun triode according to claim 1, wherein the orthogonal projection of the summit line of the protuberance projecting from the plane of the first electrode is within the aperture of this first electrode.

7. Electron gun triode according to claim 1, wherein the summit line of the projection has the shape of a first rectangle whose ratio of dimensions (a/b) determines the current density profile emitted and thus determines the ovalisation of the beam.

8. Electron gun triode according to claim 7, wherein the aperture of the first electrode has the shape of a second rectangle whose sides are parallel to those of the first rectangle, the ratio of the spacing (f-a) between the sides of both rectangles measured parallel to the second axis (X) at the spacing (g-b) between the sides measured parallel to the third axis (Y) determines the distance between the horizontal crossover and the vertical crossover, thus determining the astigmatism of the electron beam.

9. Electron gun triode according to claim 1, wherein the cathode comprises several projecting emissive zones the said projecting emissive zones not having any rotational symmetry about the first axis (Z).

10. Electron gun triode for colour cathode ray tube, comprising three triodes according to claim 1 arranged in parallel around the first axis.
